(19) United States
(12) Patent Application Publication
(10) Pub. No.: US 2014/0176828 A1
(43) Pub. Date: Jun. 26, 2014

(54) TOUCH PANEL

(71) Applicant: SAMSUNG ELECTRO-MECHANICS CO., LTD., Suwon (KR)

(72) Inventors: Jung Eun Noh, Suwon (KR); Seung Heon Han, Suwon (KR); Suk Jin Ham, Suwon (KR); Jung Tae Park, Suwon (KR); Sung Yeol Park, Suwon (KR)

(73) Assignee: SAMSUNG ELECTRO-MECHANICS CO., LTD., Suwon (KR)

(21) Appl. No.: 14/136,181

(22) Filed: Dec. 20, 2013

(30) Foreign Application Priority Data
Dec. 20, 2012 (KR) 10-2012-0149647

(51) Int. Cl. G06F 3/041

(52) U.S. Cl. CPC G06F 3/041
USPC 349/12

(57) ABSTRACT

Disclosed herein is a touch panel including a transparent substrate, a plurality of magnets positioned in both sides of the transparent substrate, ferromagnetic cores formed in one surface of the transparent substrate, and electrodes formed in one surface of the transparent substrate such that the electrodes are positioned in an outer side of the ferromagnetic cores, respectively.

### CROSS REFERENCE TO RELATED APPLICATION

This application claims the benefit of Korean Patent Application No. 10-2012-0149647, filed on Dec. 20, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

Due to the development of computers using digital technologies, auxiliary equipment of computers has also been developed, and personal computers, portable transmission devices, and other personalized information processing devices perform text and graphic processing by using various input devices such as a keyboard or a mouse.

However, the rapid increase of an information-oriented society has extended the purpose of computers, such that a currently used keyboard and mouse serving as input devices are insufficient to effectively drive products. Thus, demand for a device allowing any one to easily input information, as well as being simple and reducing the possibility of erroneous manipulation, is increasing.

In addition, interest in techniques regarding an input device, beyond a level satisfying general functions, has been shifted to reliability, durability, innovativeness, designing, processing-related technique, and the like, and in order to achieve such objects, a touch panel allowing for inputting information such as text, graphics, and the like, has been developed as an input device.

A touch panel is a tool installed on a display screen of a flat panel display device such as an electronic notebook, a liquid crystal display (LCD) device, a plasma display panel (PDP), an electroluminescence (EL), or the like, and an image display device such as a cathode ray tube (CRT), or the like, to allow users to select desired information while viewing the image display device.

Meanwhile, touch panels are classified as a resistive-type touch panel, a capacitive-type touch panel, an electromagnetic-type touch panel, a surface acoustic wave (SAW)-type touch panel, and an infrared-type touch panel. Various types of touch panel are employed in electronic products in consideration of signal amplification, difference in resolution, difficulty in designing and processing techniques, optical properties, electrical properties, mechanical properties, environment-resistant characteristics, input characteristics, durability, and economical efficiency, and currently, resistive-type touch panels and capacitive-type touch panels are widely used in extensive fields.

As disclosed in Korean Patent Laid-Open Publication No. 2012-0044268, a capacitive-type touch panel uses capacitance between two electrodes, in which some electrodes are arranged in a horizontal axis and the other electrodes are arranged in a vertical axis, forming a lattice structure, and capacitance formed at crossings of both axes is sequentially measured to detect a change in capacitance at a particular point.

However, in the case of current capacitive-type touch panels, a driving voltage is required to form an electrical field through electromagnetic induction in advance, causing power consumption.

### RELATED ART

### Patent Document

(Patent Document 1) Korean Patent Laid-Open Publication No. 2012-0044268

### SUMMARY OF THE INVENTION

The present invention has been made in an effort to provide a touch panel not in need of a driving voltage.

According to a preferred embodiment of the present invention, there is provided a touch panel including: a transparent substrate; a plurality of magnets positioned on both sides of the transparent substrate; ferromagnetic cores formed in one surface of the transparent substrate; and electrodes formed on one surface of the transparent substrate such that the electrodes are positioned on an outer side of the ferromagnetic cores, respectively.

Each of the electrodes may be wound on an outer side of each of the ferromagnetic cores.

Each of the electrodes may be formed to be spaced apart by a predetermined distance along the circumference of each of the ferromagnetic cores.

Each of the electrodes may have a circular or hexagonal pattern.

The electrodes and the ferromagnetic cores may be formed on one surface of the transparent substrate.

The electrodes and the ferromagnetic cores may be formed to be buried on one surface of the transparent substrate.

According to another preferred embodiment of the present invention, there is provided a touch panel including: a transparent substrate; ferromagnetic cores formed on one surface of the transparent substrate; electrodes formed on one surface of the transparent substrate such that the electrodes are positioned on an outer side of the ferromagnetic cores, respectively; and magnets formed on one surface of the transparent substrate such that the magnets are positioned between the ferromagnetic cores and the electrodes, respectively.

Each of the electrodes may be wound in an outer side of each of the ferromagnetic cores.

Each of the electrodes may be formed to be spaced apart by a predetermined distance along the circumference of each of the ferromagnetic cores.

Each of the magnets may be formed to be spaced apart by a predetermined distance along the circumference of each of the ferromagnetic cores.

The electrodes may be formed in positions such that the electrodes correspond to the magnets, respectively.

The electrodes and the magnets may have a circular or hexagonal pattern, respectively.

The magnets, the electrodes, and the ferromagnetic cores may be formed in one surface of the transparent substrate.

The magnets, the electrodes, and the ferromagnetic cores may be formed to be buried on one surface of the transparent substrate.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a plan view of a touch panel according to an embodiment of the present invention;

FIG. 2 is a cross-sectional view illustrating an example of a touch panel in which electrodes are formed according to an embodiment of the present invention;

FIG. 3 is a cross-sectional view illustrating another example of a touch panel in which electrodes are formed according to an embodiment of the present invention;

FIG. 4 is a plan view of a touch panel according to another embodiment of the present invention;

FIG. 5 is a cross-sectional view illustrating an example of a touch panel in which electrodes are formed according to another embodiment of the present invention; and

FIG. 6 is a cross-sectional view illustrating another example of a touch panel in which electrodes are formed according to another embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like, are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

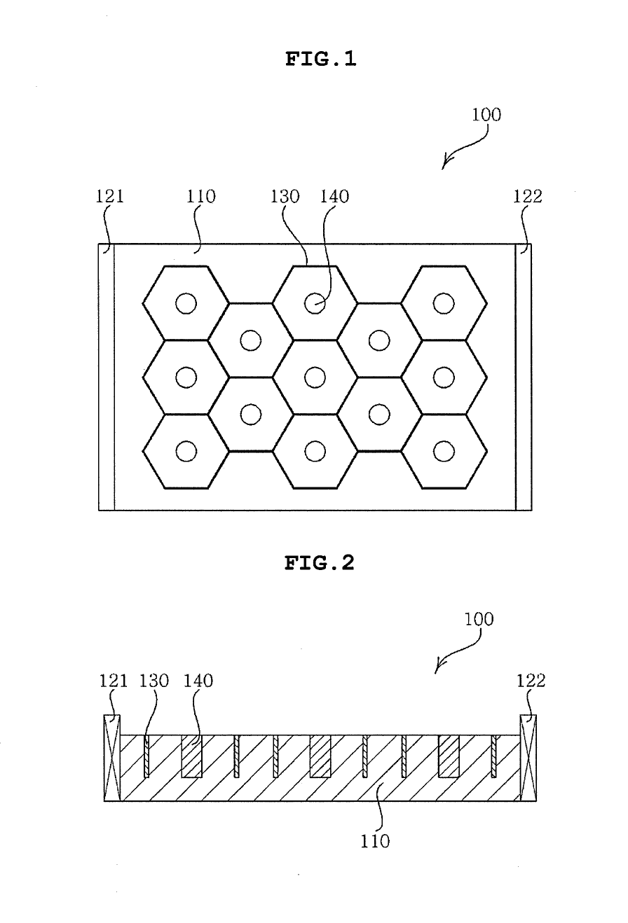

FIG. 1 is a plan view of a touch panel according to an embodiment of the present invention.

Referring to FIG. 1, a touch panel 100 according to an embodiment of the present invention includes a transparent substrate 110, magnets 121 and 122, electrodes 130, and ferromagnetic cores 140.

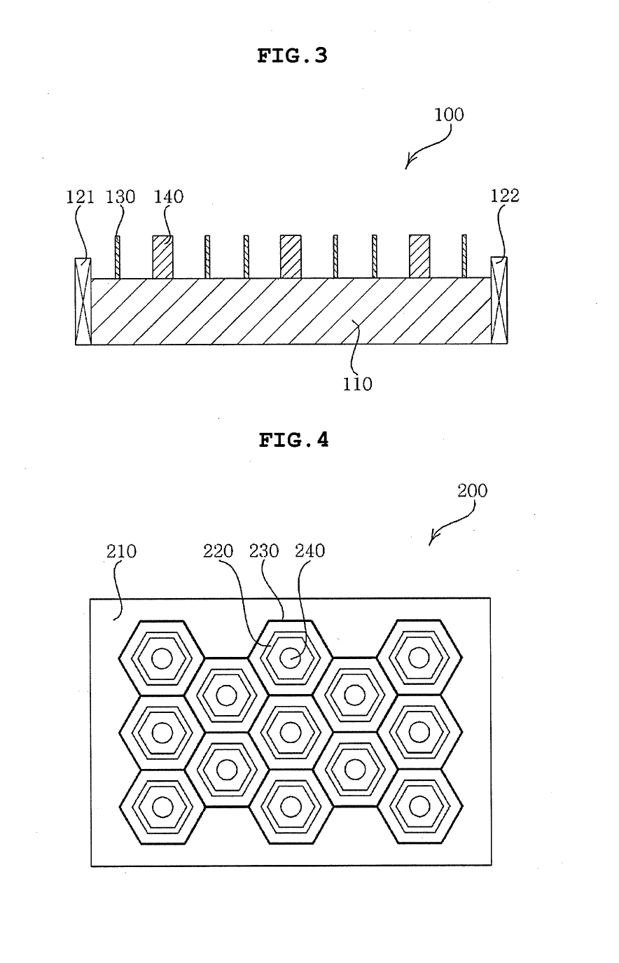

FIG. 2 is a cross-sectional view illustrating an example of a touch panel in which electrodes are formed according to an embodiment of the present invention, and FIG. 3 is a cross-sectional view illustrating another example of a touch panel in which electrodes are formed according to an embodiment of the present invention. Specifically,

FIG. 2 is a cross-sectional view illustrating a concept of forming electrodes to be buried in one surface of a transparent substrate in a touch panel, and FIG. 3 is a cross-sectional view illustrating a concept of forming electronics on one surface of a transparent substrate in a touch panel.

Hereinafter, a touch panel according to an embodiment of the present invention will be described in detail with reference to FIGS. 1 through 3.

First, the transparent substrate 110 serves to provide a region in which the electrodes 130 are to be formed. Here, the transparent substrate 110 is required to have bearing power sufficient for supporting the electrodes 130 and transparency allowing a user to recognize an image provided in an image display device (not shown). In consideration of the foregoing bearing power and transparency, the transparent substrate 110 may be made of polyethylene terephthalate (PET), polycarbonate (PC), polymethyl methacrylate (PMMA), polyethylene naphthalate (PEN), polyethersulfone (PES), a cyclic olefin copolymer (COC), triacetylcellulose (TAC) film, a polyvinyl alcohol (PVA) film, a polyimide (PI) film, polystyrene (PS), biaxially oriented PS (BOPS) (containing K resin), glass, tempered glass, or the like, but the present inventive concept is not necessarily limited thereto.

Meanwhile, in order to activate both surfaces of the transparent substrate 110, a radio frequency (RF) treatment or a primer treatment may be performed. By activating both surfaces of the transparent substrate 110, adhesive strength between the transparent substrate 110 and the electrodes 130 can be enhanced.

The magnets 121 and 122 are provided in plural on both sides of the transparent substrate 110, and a magnetic field is formed between the plurality of magnets 121 and 122. In this case, magnetic force flows from the magnet 121 positioned on one side of the transparent substrate 110 to the magnet 122 positioned in the other side thereof

Also, the magnets 121 and 122 may be configured as permanent magnets.

The ferromagnetic cores 140 are formed in plural on one surface of the transparent substrate 110. Here, the ferromagnetic cores 140 are positioned between the plurality of magnets 121 and 122 provided on both sides of the transparent substrate 110.

The ferromagnetic cores 140 may have a cylindrical shape, for example, but the present inventive concept is not limited thereto.

The electrodes 130 may be formed on one surface of the transparent substrate 110 such that they are positioned on outer sides of the ferromagnetic cores 140, respectively.

Here, the electrodes 130 may be wound along the outer surfaces of the ferromagnetic cores 140 or may be positioned to be spaced apart from the ferromagnetic cores 140 by a predetermined distance, respectively. In this case, the electrodes 130 may be configured as coils, for example, but the present inventive concept is not limited thereto.

Meanwhile, the ferromagnetic cores 140 and the electrodes 130 are formed in plural, and the plurality of electrodes 130 may form patterns disposed to be spaced apart from one other by a predetermined distance along the circumferences of the plurality of ferromagnetic cores 140. Here, the electrodes 130 may form a plurality of circular or hexagonal patterns, but the present inventive concept is not limited thereto.

Meanwhile, in the touch panel 100 according to an embodiment of the present invention, for example, the electrodes 130 and the ferromagnetic cores 140 may be formed on one surface of the transparent substrate 110 (please see FIG. 2).

Also, in another example, in the touch panel 100 according to an embodiment of the present invention, the electrodes 130 and the ferromagnetic cores 140 may be formed to be buried on one surface of the transparent substrate 110 (please see FIG. 3).

Hereinafter, operations of the touch panel according to an embodiment of the present invention configured as described above will be described.

In the touch panel 100 according to an embodiment of the present invention, when a user touches a portion near the ferromagnetic core 140, a body temperature of the user's finger is transmitted to the ferromagnetic core 140 and a temperature of the ferromagnetic core 140 is increased by the transmitted heat to cause a great amount of magnetization. Accordingly, a magnetic field flowing between the magnets 121 and 122 disposed on both sides of the transparent substrate 110 is changed to induce a current in the electrode 130 in the proximity of the ferromagnetic core 140. Then, a sensor (not shown) connected to the electrode 130 senses the induced current to sense the touch.

FIG. 4 is a plan view of a touch panel according to another embodiment of the present invention.

Referring to FIG. 4, a touch panel according to another embodiment of the present invention includes a transparent substrate 210, magnets 220, electrodes 230, and ferromagnetic cores 240.

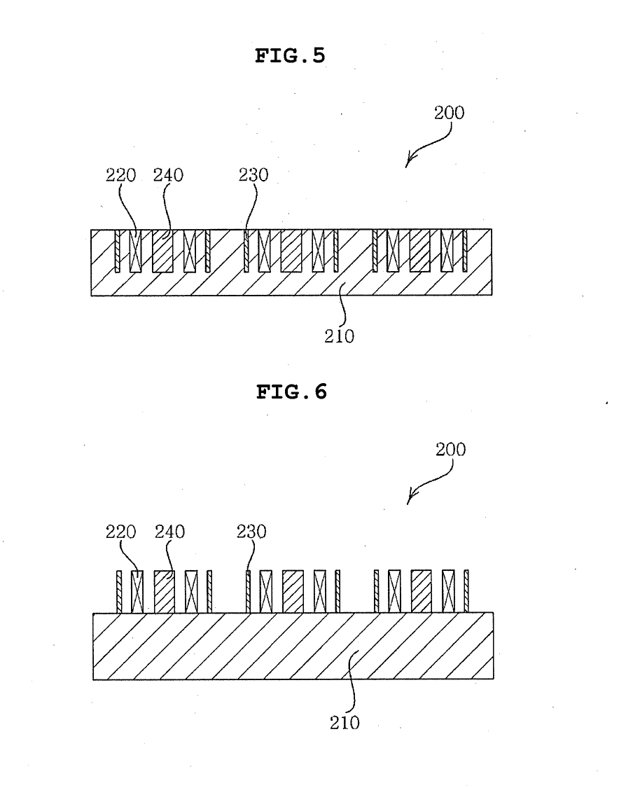

FIG. 5 is a cross-sectional view illustrating an example of a touch panel in which electrodes are formed according to another embodiment of the present invention, and FIG. 6 is a cross-sectional view illustrating another example of a touch panel in which electrodes are formed according to another embodiment of the present invention.

Specifically, FIG. 5 is a cross-sectional view illustrating a concept of forming electrodes to be buried in one surface of a transparent substrate in a touch panel, and FIG. 6 is a cross-sectional view illustrating a concept of forming electrodes on one surface of a transparent substrate in a touch panel.

Hereinafter, a touch panel according to another embodiment of the present invention will be described in detail with reference to FIGS. 4 through 6.

First, the transparent substrate 210 serves to provide a region in which the electrodes 230 are to be formed. Here, the transparent substrate 210 is required to have bearing power sufficient for supporting the electrodes 230 and transparency allowing a user to recognize an image provided in an image display device (not shown). In consideration of the foregoing bearing power and transparency, the transparent substrate 210 may be made of polyethylene terephthalate (PET), polycarbonate (PC), polymethyl methacrylate (PMMA), polyethylene naphthalate (PEN), polyethersulfone (PES), a cyclic olefin copolymer (COC), triacetylcellulose (TAC) film, a polyvinyl alcohol (PVA) film, a polyimide (PI) film, polystyrene (PS), biaxially oriented PS (BOPS) (containing K resin), glass, tempered glass, or the like, but the present inventive concept is not necessarily limited thereto.

Meanwhile, in order to activate both surfaces of the transparent substrate 210, a radio frequency (RF) treatment or a primer treatment may be performed. By activating both surfaces of the transparent substrate 210, adhesive strength between the transparent electrode 210 and the electrodes 230 can be enhanced.

The ferromagnetic cores 240 are formed in one surface of the transparent substrate 210. The ferromagnetic cores 240 may have a cylindrical shape, for example, but the present inventive concept is not limited thereto.

The electrodes 230 may be formed on one surface of the transparent substrate 210 such that they are positioned on outer sides of the ferromagnetic cores 240, respectively.

Here, the electrodes 230 may be wound along the outer surfaces of the ferromagnetic cores 240 or may be positioned to be spaced apart from the ferromagnetic cores 240 by a predetermined distance, respectively. In this case, the electrodes 230 may be configured as coils, for example, but the present inventive concept is not limited thereto.

The magnets 220 are formed on one surface of the transparent substrate 210 and positioned between the electrodes 230 and the ferromagnetic cores 240, respectively. Here, the magnets 220 may be wound along the circumferences of the ferromagnetic cores 240 or may be positioned to be spaced apart from the ferromagnetic cores 240 by a predetermine distance, respectively.

Also, the magnets 220 may be configured as permanent magnets.

Meanwhile, the ferromagnetic cores 240, the electrodes 230, and the magnets 220 may be formed in plural to form patterns.

Here, the plurality of electrodes 230 may form patterns disposed to be spaced apart by a predetermined distance along the circumferences of the plurality of ferromagnetic cores 240, respectively. Also, the plurality of magnets 220 may form patterns disposed to be spaced apart by a predetermined distance along the circumferences of the plurality of ferromagnetic cores 240, respectively. In this case, the electrodes 230 may be disposed to be spaced apart from outer surfaces of the magnets 220 by a predetermined distance and may be formed to correspond to the shape of the magnets 220, respectively.

The electrodes 230 and the magnets 220 may form a plurality of hexagonal patterns.

Meanwhile, in the touch panel 200 according to another embodiment of the present invention, for example, the magnets 220, the electrodes 230, and the ferromagnetic cores 240 may be formed on one surface of the transparent substrate 210 (please see FIG. 5).

Also, in another example, in the touch panel 200 according to another embodiment of the present invention, the magnets 220, the electrodes 230, and the ferromagnetic cores 240 may be formed to be buried in one surface of the transparent substrate 210 (please see FIG. 6).

Hereinafter, operations of the touch panel according to another embodiment of the present invention configured as described above will be described.

In the touch panel 200 according to an embodiment of the present invention, when a user touches a portion near the ferromagnetic core 240, a body temperature of the user's finger is transmitted to the ferromagnetic core 240 and a temperature of the ferromagnetic core 240 is increased by the transmitted heat to cause a great amount of magnetization. Accordingly, a magnetic field of the magnets 220 disposed on outer sides of the ferromagnetic cores 240 is changed to induce a current in the electrode 230 in the proximity of the ferromagnetic core 240. Then, a sensor (not shown) connected to the electrode 230 senses the induced current to sense the touch.

According to the preferred embodiments of the present invention, since a driving voltage for forming an electric field is not required, power may not be consumed.

Although the embodiments of the present invention have been disclosed for illustrative purposes, it will be appreciated that the present invention is not limited thereto, and those skilled in the art will appreciate that various modifications, additions, and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A touch panel comprising:
a transparent substrate;
a plurality of magnets positioned on both sides of the transparent substrate;
ferromagnetic cores formed on one surface of the transparent substrate; and
electrodes formed on one surface of the transparent substrate such that the electrodes are positioned on an outer side of the ferromagnetic cores, respectively.

2. The touch panel as set forth in claim 1, wherein each of the electrodes is wound on an outer side of each of the ferromagnetic cores.

3. The touch panel as set forth in claim 1, wherein each of the electrodes is formed to be spaced apart by a predetermined distance along the circumference of each of the ferromagnetic cores.

4. The touch panel as set forth in claim 1, wherein each of the electrodes has a circular or hexagonal pattern.

5. The touch panel as set forth in claim 1, wherein the electrodes and the ferromagnetic cores are formed on one surface of the transparent substrate.

6. The touch panel as set forth in claim 1, wherein the electrodes and the ferromagnetic cores are formed to be buried on one surface of the transparent substrate.

7. A touch panel comprising:
a transparent substrate;
ferromagnetic cores formed on one surface of the transparent substrate;
electrodes formed on one surface of the transparent substrate such that the electrodes are positioned on an outer side of the ferromagnetic cores, respectively; and
magnets formed on one surface of the transparent substrate such that the magnets are positioned between the ferromagnetic cores and the electrodes, respectively.

8. The touch panel as set forth in claim 7, wherein each of the electrodes is wound on an outer side of each of the ferromagnetic cores.

9. The touch panel as set forth in claim 7, wherein each of the electrodes is formed to be spaced apart along the circumference of each of the ferromagnetic cores.

10. The touch panel as set forth in claim 9, wherein each of the magnets is formed to be spaced apart by a predetermined distance along the circumference of each of the ferromagnetic cores.

11. The touch panel as set forth in claim 10, wherein the electrodes are formed in positions such that the electrodes correspond to the magnets, respectively.

12. The touch panel as set forth in claim 7, wherein the electrodes and the magnets have a circular or hexagonal pattern, respectively.

13. The touch panel as set forth in claim 7, wherein the magnets, the electrodes, and the ferromagnetic cores are formed on one surface of the transparent substrate.

14. The touch panel as set forth in claim 7, wherein the magnets, the electrodes, and the ferromagnetic cores are formed to be buried on one surface of the transparent substrate.
